(19) United States
(12) Patent Application Publication
(10) Pub. No.: US 2007/0114981 A1
(43) Pub. Date: May 24, 2007

(54) Switching power supply system with pre-regulator for circuit or personnel protection devices

(75) Inventors: Jacinto R. Vasquez, Marion, IA (US); Steven M. Meehleder, Cedar Rapids, IA (US)

Correspondence Address: SQUARE D COMPANY;LEGAL DEPARTMENT - I.P. GROUP, 1415 SOUTH ROSELLE ROAD, PALATINE, IL, 60067, US

(73) Assignee: Square D Company

(21) Appl. No.: 11/284,194

(22) Filed: Nov. 21, 2005

(51) Int. Cl. G05F 1/00

(52) U.S. Cl. 323/266

(57) ABSTRACT

A linear pre-regulator for cascading with a switching regulator for providing a load current for a circuit or personnel protection device includes a transistor for providing a series variable resistance when a load current changes. The series variable resistance includes a control node, and a control part maintains a substantially fixed voltage at the control node when the current drawn by the switching regulator changes. A storage part may be included to provide a voltage at a drain of a transistor forming the series variable resistance during an OFF-to-ON transition of the transistor.

### BACKGROUND OF THE INVENTION

1. Field of the Invention

The present invention relates generally to a power supply system, and more particularly to a switching power supply system with a pre-regulator for a circuit or personnel protection device.

2. Background of the Invention

Current power supply systems for circuit and personnel protection devices use pre-regulator/regulator IC combinations that include multiple inductors, or large value/package inductors, transformers or capacitors. Such systems have relatively low power efficiencies, e.g., more than 1 Watt @40 mA, and a relatively narrow range of voltage inputs. The current systems also require a relatively large amount of printed circuit board space and relatively high parts count, trace runs, etc.

### SUMMARY OF THE INVENTION

The present invention provides a switching power supply system for a circuit or personnel protection device. The system comprises an input stage for outputting a rectified signal, a switching regulator for outputting a DC output signal, a pre-regulator in cascade between the input stage and the switching regulator, and an output stage for filtering noise from the DC output signal. The pre-regulator includes a transistor for providing variable resistance, and a control part for maintaining a substantially fixed voltage at a gate of the transistor.

In one embodiment, the rectified signal from the input stage is linearly pre-regulated with a series variable resistance that decreases in response to increases in current drawn by the switching regulator and increases in response to decreases in the current drawn.

In a preferred embodiment, the transistor has a drain connected to a storage component such as a capacitor that stores energy to be used during the transistor's off-to-on transition, so as to reduce surge current switching noise effects on the AC input voltage. A gate control element such as a zener diode may be used to prevent the transistor's gate-to-source voltage from exceeding its maximum peak voltage during the transistor's switched-on transitions.

It is to be understood that both the foregoing general description and the following detailed description are exemplary and are intended to provide further explanation of the invention as claimed.

### BRIEF DESCRIPTION OF THE DRAWINGS

FIG. 1 is an exemplary block diagram representation of a switching power supply system according to an embodiment of the present invention.

FIG. 2 is a schematic diagram of the switching power supply system shown in FIG. 1.

### DETAILED DESCRIPTION OF THE PREFERRED EMBODIMENTS

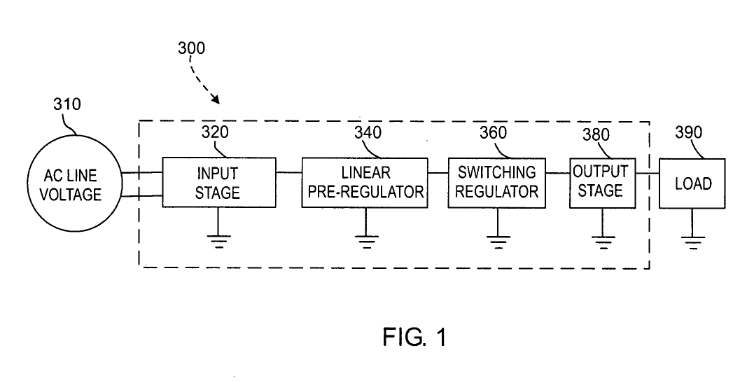

FIG. 1 is an exemplary block diagram of a switching power supply system according to an embodiment of the present invention. Referring to FIG. 1, the switching power supply system 300 includes an input stage 320, a linear pre-regulator 340, a switching regulator 360, and an output stage 380. An alternating current (AC) power source 310 can be electrically connected to the input stage 320 for providing an input voltage to the switching power supply system 300. For example, the AC power source 310 may provide a standard electrical signal having a 60 Hz frequency and a 120V AC voltage. A load 390 can be connected to an output of the output stage 380 to be powered by the switching power supply system 300. For example, the load 390 can have a resistance of 165Ω and draw a current of about 40 mA. The input stage 320 provides a rectified voltage to an input of the linear pre-regulator 340. Thus, the input stage 320 provides power to the following stages of the switching power supply system 300, for example, the linear pre-regulator 340, the switching regulator 360, and the output stage 380. In addition, the input stage 320 can control the linear pre-regulator 340.

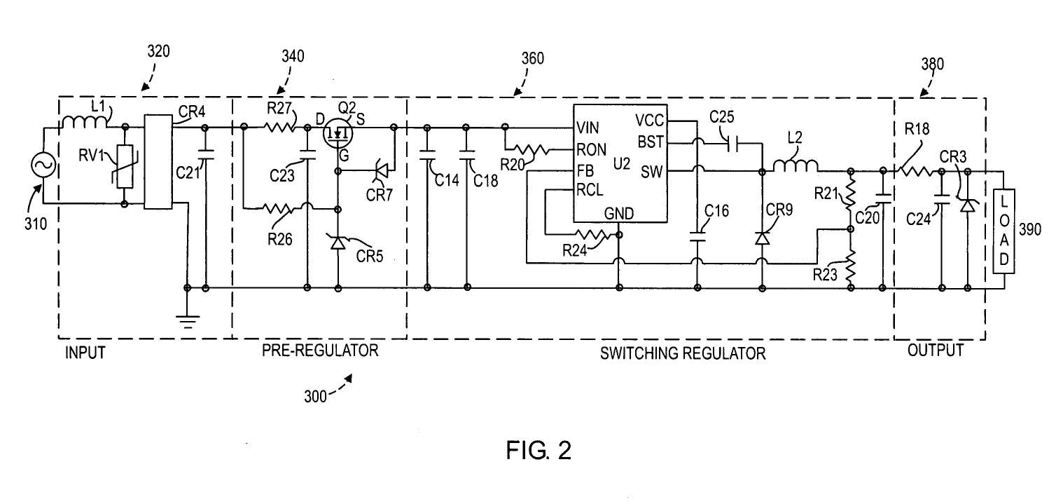

FIG. 2 is an exemplary schematic circuit diagram of the switching power supply system of FIG. 1. Referring to FIG. 2, the AC voltage received at the input of the input stage 320 can be rectified by a bridge rectifier CR4. The rectified voltage can be a pulsating direct current (DC) waveform having a frequency of 120 Hz and a peak voltage of 170V. The input stage 320 can include a trip solenoid L1 in series with the bridge rectifier CR4. A varistor RV1 can be electrically connected between input terminals of the bridge rectifier CR4. A capacitor C21 can be provided at the output of the bridge rectifier CR4 to suppress voltage transients at the output of the input stage 320.

In an embodiment of the present invention, the bridge rectifier CR4 is selected to provide a maximum peak reverse voltage of 187V, a continuous reverse current of 25 mA, a 3.5 A rms forward current during a trip operation, and a peak surge of 350V. The selected trip solenoid L1 can have an internal inductance of 9 mH and an internal resistance of 48 ohm. The varistor RV1 can have a standoff rating of 150V rms and a voltage clamping of 350V. The capacitor C21 can have a capacitance of 0.01 μF and is selected is to provide a frequency rolloff at 17 kHz in conjunction with the trip solenoid L1.

The linear pre-regulator 340 provides linear step-down regulation of the voltage to be applied at the input of the switching regulator 360. The pre-regulator 340 is connected in cascade between the input stage 320 and the switching regulator 360. The pre-regulator 340 can include, for example, an N-channel enhancement MOSFET series-pass transistor Q2. A resistor R26 and a zener diode CR5 can provide gate control for the transistor Q2. A current limiting resistor R27 and a storage capacitor C23 can also be provided. The linear pre-regulator can also include a second zener diode CR7.

As shown in FIG. 2, the transistor Q2 can be connected in a source follower configuration. The zener diode CR5 and the resistor R26, which are connected in series with each other, provide gate control for the transistor Q2. The zener diode CR5 provides an electrical path between a gate of the transistor Q2 and a ground of the switching power supply system 300. The resistor R26 provides an electrical path between the gate G of the transistor Q2 and the output of the input stage 320. Thus, the zener diode CR5 and the resistor R6 maintain the transistor Q2 in a partially-on linear mode. Hence, the transistor Q2 operates more efficiently.

The transistor Q2 acts as a variable resistor controlled by the gate controller, which includes the zener diode CR5 and the resistor R26. When a current from the switching power source 300 into the load 390 increases, the source voltage at the input of the pre-regulator 340 decreases. However, the zener diode CR5 maintains a constant voltage at the gate G of the transistor Q2. Hence, the drop in the source voltage at the input of the pre-regulator 340 causes an increase in a forward bias current of the transistor Q2. Thus, a drain-to-source resistance of the transistor Q2 also decreases. The decrease in drain-to-source resistance causes a corresponding increase in the source voltage at the input of the pre-regulator 340 back to its original value. When the current from the switching power source 300 into the load 390 decreases, the source voltage at the input of the pre-regulator 340 increases. However, the zener diode CR5 maintains a constant voltage at the gate G of the transistor Q2. Hence, the increase in the source voltage at the input of the pre-regulator 340 causes a decrease in a forward bias current of the transistor Q2. Thus, a drain-to-source resistance of the transistor Q2 also increases. The increase in drain-to-source resistance causes a corresponding decrease in the source voltage at the input of the pre-regulator 340 down to its original value.

As shown in FIG. 2, the current limiting resistor R27 electrically connects a drain D of the transistor Q2 to the output of the input stage 320. Resistor R27 limits the source-to-drain current within the transistor Q2 and the current drawn by the switching regulator 360 at the output S of the pre-regulator 340.

The storage capacitor C23 electrically connects the drain D of the transistor Q2 to ground. The capacitor C23 provides energy storage capability to the pre-regulator 340. For example, the capacitor C23 stores energy to be used by the transistor Q2 during an initial off-to-on transition. The initial OFF-to-ON transition of the transistor Q2 can occur once every 120 Hz cycle, for example. The capacitor C23 also provides filtering capability to reduce a surge current switching noise caused by the power supply system 300. Thus, the power supply system can quickly start operating after the initial OFF-to-ON transition.

A second zener diode CR7 can be provided between the source S and the gate G of the transistor Q2. The zener diode CR7 limits the gate-to-source voltage of the transistor Q2 when the transistor Q2 is switched on. For example, the zener diode CR7 can prevent the OFF-to-ON transition gate-to-source voltage from exceeding a maximum peak voltage of the transistor Q2.

In one embodiment, the MOSFET transistor Q2 is selected to provide a continuous drain current of about 140 mA, a maximum drain current of about 600 mA, a drain-to-source voltage of about 450V, and a gate-to-source voltage of about +/−20V max. The maximum power output by the MOSFET transistor Q2 is about 2 W. The gate voltage limiting diode CR5 provides a zener voltage in a range of about 78 V to about 86 V. The zener diode CR5 can provide a voltage of about 82V at the gate of the transistor Q2, and the resistor R26 can have a resistance of about 249 kilohms. The current-limiting resistor R27 can have a resistance of about 1.5 Kilohms. The capacitor C23 can have a capacitance of about 0.056° F. for effective high frequency filtering. The zener diode CR7 provides voltage limiting capability to a value of about 18V, well below the 20V peak gate-to-source voltage of the transistor Q2. Hence, the pre-regulator 340 maintains a voltage of about 80V at its output S.

The switching regulator 360 takes as input the regulated voltage generated by the pre-regulator 340 and outputs a desired voltage to power the load 390. For example, the switching regulator converts the 80VDC supplied by the pre-regulator 340 and outputs a 5VDC voltage. In one embodiment, the switching regulator 360 includes an IC U2, which can be a step-down DC/DC buck bias switching regulator, such as the prepackaged National Semiconductor LM5008. The IC U2 converts the regulated input voltage to a low output voltage. The switching regulator 360 includes additional circuitry to interface the IC U2 with the pre-regulator 340 and the output stage 380.

Referring to FIG. 2, the output of the pre-regulator 340 is electrically connected to an input Vin of the IC U2. A capacitor C14 is provided at an input Vin of the IC U2 to attenuate voltage transients and noise. Another capacitor C18 is provided at the input Vin for supplying a final output switched current during an ON time of the IC U2 and to limit a voltage ripple at the input Vin. An on-time resistor R20 is provided between inputs Vin and Ron of the IC U2 to set a switching on-time of the IC U2 to an appropriate value. The on-time is inversely proportional to the input voltage and provides hysteretic control for the IC U2. A current-limiting resistor R24 is provided between an output Rcl of the IC U2 and the ground to set a minimum forced OFF time.

A capacitor C16 is provided to filter and stabilize an internal power supply Vcc of the IC U2. A capacitor C25 is electrically connected between outputs BST and SW of the IC U2 to provide a surge current for charging a switch gate at turn-on. A re-circulating or catch diode CR9 provides a path from the output SW of the IC U2 to the ground.

An inductor L2 electrically connects the output of the IC U2 to the output of the switching regulator 360. A filter capacitor C20 is provided at the output of the switching regulator 340 to filter noise from the DC output. The capacitance and equivalent series resistance (ESR) of the capacitor C20 generate a feedback ripple voltage for the switching IC U2. The feedback ripple voltage can have a peak-to-peak value of about 50 mV, for example.

Voltage-divider resistors R21 and R3 are provided to regulate the low voltage output of the switching regulator 360. The resistors R21 and R23 are electrically connected in series with each other to provide a path from the output of the switching regulator 360 to ground. The voltage across resistor R23 is applied as a feedback signal to an input FB of the IC U2.

During the on-time of the IC U2, an inductor current ramps up linearly to charge the inductor L2. Thus, the inductor L2 stores energy during the on-time of the IC U2. During the OFF time of the IC U2, the catch diode CR9 becomes forward-biased and directs a local off-time current loop to the load 390 through an inductor L2. Thus, the inductor current is drained during the off-time of the IC U2.

The IC U2 can sustain a maximum input voltage of about 100V and a maximum input current of 610 mA and can operate in a range of about −40 to 125° C. The on-time resistor R20 can be selected to set the switching on-time of the IC U2 to about 400 ns with a time-off value of about 4.6 μs. The minimum forced OFF time of the IC U2 is set to about 500 ns with an on-time of 4.5 ns. The internal power supply Vcc can have a DC voltage output of about 7V. The inductor L2 and the capacitor C20 are selected to provide a discontinuous switching frequency in a range of about 150 KHz to about 220 KHz. Thus, the switching regulator 360 converts the DC voltage of about 80V supplied by the pre-regulator 340 to a DC output of about 5V by supplying a 200 KHz/80V-peak pulse to the 220 μH inductor, which stores and releases energy during ON and OFF times of the IC U2, respectively.

In one embodiment, the inductor L2 can have an inductance of about 220 μH and the capacitor C20 can have a capacitance of about 10 μF. The filtering capacitor C14 can have a capacitance of about 0.1 μF. The capacitor C18 can have a capacitance of about 1.0 μF. The resistor R20 can have a resistance of about 255 KΩ for setting the switching on-time of the IC U2. The ON time is inversely proportional to the input voltage and provides hysteretic control for the IC U2. The current-limiting resistor R24 can have a resistance of about 20 KΩ for setting the minimum forced OFF time. The filtering capacitor C16 can have capacitance of about 0.1 μF. The capacitor C25 can have a capacitance of about 0.01 μF. Voltage-divider resistors R21 and R23 can have values of 1.62 KΩ and 1 KΩ, respectively.

Still referring to FIG. 2, the output stage 380 includes a resistor R18 and a capacitor C24 to provide RC-filtering of any noise frequencies caused by the switching regulator 360. The capacitor C24 provides a path from the output of the output stage 380 to ground. The capacitor C24 can have a capacitance value of 0.001 μF. The resistor R18 electrically connects the switching regulator 360 to the output of the output stage 380. The RC filter formed by resistor R18 and capacitor C24 filters noise frequencies above a specified frequency, for example above 5 MHz. The resistor R18 can have a resistance of about 1.31Ω. A zener diode CR3 can be provided in parallel with the capacitor C24 at the output of the output stage 380. The zener diode CR3 limits the output voltage to a maximum voltage, for example 6V peak.

In one particular application, the load 390 in the system of FIG. 2 is an application specific integrated circuit (ASIC) that is described in copending U.S. application Ser. No. 09/026,556, filed Feb. 19, 1998, entitled “Electrical Fault Detection System,” owned by the assignee of the present application and incorporated herein by reference. The output from the switching power supply system 300 is electrically connected to the high positive ASIC supply voltage input pin VSUP of the ASIC. A capacitor can be provided between the input terminal VSUP and ground to filter out unwanted signals, such as a noise signal.

When a trip decision is reached by the ASIC, a trip signal buffer latches and drives the gate of a silicon controlled rectifier (SCR 98 in the copending application) having its anode connected to the output of the diode bridge CR4. In the ON state, the SCR causes the coil L1 (coil 100 in the copending application) to be momentarily shorted across the line to mechanically de-latch the contacts of the host device and to subsequently interrupt flow of current.

According to embodiments of the present invention, a wide range switching power supply system having high efficiency and a quick start capability is provided by combining a linear pre-regulator having a gate control together with a switching regulator. Embodiments of the present invention can be implemented as an ASIC that would require limited external components. The DC output voltage provided by the linear pre-regulator can be adjusted to a desired value by appropriate selection of the zener diode in the gate control part. Other components, like resistors and capacitors, can be selected to adjust the final DC output voltage, the switching characteristics, and the load current capability of the switching power supply system. In contrast to the related art power supplies, the switching power supply system according to embodiments of the present invention does not require or use multiple inductors or large value inductors, transformers or capacitors.

It will be apparent to those skilled in the art that various modifications and variations can be made in the switching power supply system with pre-regulator for circuit or personnel protection devices of the present invention without departing from the spirit or scope of the invention. Thus, it is intended that the present invention cover the modifications and variations of this invention provided they come within the scope of the appended claims and their equivalents.

What is claimed is:

1. A switching power supply system for a circuit or personnel protection device, comprising:
an input stage for outputting a rectified signal;
a switching regulator for outputting a DC output signal;
a pre-regulator in cascade between the input stage and the switching regulator, the pre-regulator including a transistor for providing variable resistance, and a control part for maintaining a fixed voltage at a gate of the transistor; and
an output stage for filtering noise from the DC output signal.

2. The switching power supply system of claim 1, wherein the transistor is connected in a source follower mode.

3. The switching power supply system of claim 1, wherein the pre-regulator is a linear pre-regulator.

4. The switching power supply system of claim 1, wherein the control part includes a zener diode connected between the gate of the transistor and a ground.

5. The switching power supply system of claim 1 wherein the control part includes a voltage dividing resistor connected between an output of the input stage and the gate of the transistor.

6. The switching power supply system of claim 1, further including a current limiting resistor between the control part and a drain of the transistor for limiting a current from the source of the transistor to the switching regulator.

7. The switching power supply system of claim 1, further including a circuit or personnel protection device coupled to said output stage.

8. The switching power supply system of claim 7, wherein said circuit or personnel protection device is a circuit breaker or a surge protector.

9. The switching power supply system of claim 1 implemented as an ASIC.

10. The switch power supply system of claim 1 which includes a storage part for providing a voltage at a drain of the transistor during an OFF-to-ON transition of the transistor.

11. A system board for a circuit or personnel protection device, comprising:
an integrated circuit receiving a load current;
a switching power supply system; and
an interface circuit for interfacing the switching power supply system to the integrated circuit,
wherein the switching power supply system includes a linear pre-regulator in cascade with a switching regulator, the linear regulator including a transistor for providing a variable resistance, a control part for maintaining a fixed voltage at a gate of the transistor, and a storage part for providing a voltage at a drain of the transistor during an OFF-to-ON transition of the transistor.

12. A switching power supply system for a circuit or personnel protection device, comprising:
an input stage for outputting a rectified signal;
a switching regulator for outputting a DC output signal;
a linear pre-regulator coupled between the input stage and the switching regulator, the pre-regulator including a series variable resistance that decreases in response to increases in a current drawn by the switching regulator and increases in response to decreases in the current drawn, said series variable resistance including a control node, and a control part for maintaining a substantially fixed voltage at said control node; and
an output stage coupling the DC output signal to a load.

13. The switching power supply system of claim 12, wherein the series variable resistance includes a transistor.

14. A method of providing a load current to a circuit or personnel protection device, comprising:
pre-regulating a rectified signal through a transistor cascaded with a switching regulator for providing a variable resistance when a load current changes; and
maintaining a fixed voltage at a gate of the transistor when the load current changes.

15. The method of claim 14 which further includes storing a voltage for providing the stored voltage at a drain of the transistor during an OFF-to-ON transition of the transistor.

16. A method of supplying power to a circuit or personnel protection device, comprising:
outputting a rectified signal at an input stage;
receiving said rectified signal in a switching regulator and outputting a DC output signal from said switching regulator;
linearly pre-regulating said rectified signal between said input stage and said switching regulator with a series variable resistance that decreases in response to increases in a current drawn by the switching regulator and increases in response to decreases in the current drawn; and
coupling said DC output signal to a load.

17. The method of claim 16, wherein said series variable resistance includes a transistor having a gate, and further including maintaining a fixed voltage at said gate.
